(19) United States
(12) Patent Application Publication
(10) Pub. No.: US 2009/0078473 A1
(43) Pub. Date: Mar. 26, 2009

(54) Handwriting Capture For Determining Absolute Position Within A Form Layout Using Pen Position Triangulation

(75) Inventors: Kenneth J. Overgard, Cambridge, MA (US); Jason M. Soulier, Salt Lake City, UT (US)

Correspondence Address: Workman Nydegger;1000 Eagle Gate Tower, 60 East South Temple, Salt Lake City, UT, 84111, US

(73) Assignee: DIGITAL PEN SYSTEMS, Salt Lake City, UT (US)

(21) Appl. No.: 11/861,983

(22) Filed: Sep. 26, 2007

(51) Int. Cl. G06F 3/041; G01S 5/16

(52) U.S. Cl. 178/18.01; 178/19.01

(57) ABSTRACT

The invention relates to systems and methods for performing pen position triangulation for handwriting capture on forms. In one example, a system includes a base body configured to be placed over a form. The base body includes at least one receiver for receiving a multilateration signal from an emitter located on a writing utensil. A processor performs multilateration (e.g., triangulation) to determine a relative position of the writing utensil's emitter. A memory stores the relative position of the emitter. A detector detects an orientation identifier and/or form identifier located on the form. The orientation identifier and/or form identifier are used to determine an absolute position of the emitter with respect to the form.

### BACKGROUND OF THE INVENTION

1. The Field of the Invention

The present invention relates generally to digital pen technology and paper form processing. More specifically, the present invention relates to methods and systems for handwriting capture for determining absolute position of handwriting within a form layout via pen position triangulation technology in the context of a form layout.

2. The Relevant Technology

In an ideal digital pen system, a user is able to write or draw using tools that appear from the user's perspective to be conventional writing tools, e.g., a pen and paper. In one example, the digital pen displays the user's writings and drawings on a paper form, but at the same time, the digital pen records the user's writings and drawings in a digital format so that the user's handwriting may be transmitted, reproduced, and/or analyzed at a remote location.

Three primary techniques have been used for implementing a digital pen system. First is a pressure based system, where the user places a paper over a pressure sensor, writes on the paper, and the pressure sensor detects and records the application of pressure to the paper. This technique has many shortcomings, including the unintended recording of pressure applied by a non-writing item, the non-recording of a writing item when insufficient pressure is applied, inaccuracies when too many sheets of paper separate the pen from the pressure sensor, determining the orientation of a form placed on the pressure sensor, the expense of the pressure sensor, and the like.

A second technique for implementing a digital pen system includes utilizing a patterned paper in conjunction with a digital pen to create handwritten digital documents. A printed dot pattern uniquely identifies the absolute position coordinates on the paper. When a user writes on the patterned paper, a camera on the pen records the portion of the dot pattern that is being written on by the pen. Because every position on the paper has a unique dot pattern, the data collected by the pen can be uploaded to a computer and translated into digital handwriting. The patterned paper technique also has limitations, including the requirement of possessing a high resolution printer, the high cost of the pen, and an unsightly pattern printed on each piece of paper.

A third technique for implementing a digital pen system includes using a pen position triangulation for detecting the relative position of the tip of a pen with respect to a sensor. Typically, a receiver having two reception points is located next to a form, and the tip of a pen is equipped with an emitter for emitting a signal that is received by the two reception points. Using the signals received from the pen, the receiver is able to calculate and record the precise relative position of the tip of the pen with respect to the receiver. The recorded information can then be converted to handwritten documents. Although pen position triangulation can be less expensive than the pressure based or patterned paper techniques, the pen position triangulation system also has its shortcomings when used in a practical environment, such as when a user is writing on a sheet of paper that is offset, rotated, or misaligned from the receiver.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates an example pen position triangulation system including a sheet of paper;

FIG. 1B illustrates the sheet of paper shown in FIG. 1A, including an identifier used for determining the orientation of the sheet of paper;

FIG. 2 illustrates one example of a schematic diagram of a base station used for performing pen position triangulation; and

FIG. 3 illustrates one example of a method for performing handwriting capture to determine the absolute position of a digital pen.

FIG. 4 illustrates another example of a method for performing handwriting capture to determine the absolute position of a digital pen.

### DETAILED DESCRIPTION

In the following detailed description of the embodiments of the invention, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

Embodiments of the present invention provide for methods and systems for determining absolute pen positioning using, among other things, pen position triangulation. As used herein, the term “relative position” of a digital pen refers to the location of the pen with respect to a device that is detecting the location of the pen. However, relative position does not measure where the pen is in relation to a form or other form. For instance, a sheet of paper may be mounted on a clipboard to enable a user to write on the form using a digital pen. The clipboard may receive the sheet of paper in any number of orientations. For example, the paper may be either substantially aligned or misaligned (such as offset in either the x or y direction and/or rotated) with a boundary of the clipboard surface. Conventional pen triangulation systems only calculate the relative position of the pen and do not take into account the orientation of the sheet of paper. Therefore, in conventional pen triangulation systems, the digitized writing that is captured may lose some or all of its meaning if the absolute position of the pen with respect to the orientation of the paper is unknown.

Additionally, conventional pen triangulation systems do not take into consideration the form on which the user is writing. There are many situations where it is desired to be able to identify a paper form with form data fields and correlate the captured data with the data fields to reproduce the handwriting as well as perform handwriting recognition. With no link between the pen and the unique paper form, it is difficult to interpret any form data fields that may have been completed by the same pen. In addition, knowing information about a form besides just the fields it contains can be useful when performing automated functions on the form, which will be described in further detail below.

Thus, as used herein, the term “absolute position” refers to any information that provides context to the relative position of the writing utensil. As mentioned above, the orientation of the form can provide significant information about the location of the pen with respect to the form. In one embodiment, the methods and systems described herein may be used for determining the orientation of a sheet of paper with respect to the location of a base station such that the orientation of the paper may be taken into account when generating a digital handwritten document. In accordance with one embodiment of the invention, an orientation identifier is located on the form at a known location. In another embodiment, the methods and systems may be used for determining the instance of a form to provide context for the handwriting captured in certain areas of the form. Thus, in accordance with one embodiment of the invention, a form identifier is located on the form at a known location. The form identifier and orientation identifier can be the same identifier or can be provided using different identifiers.

In one exemplary process, a base station may be placed over a form identifier and/or orientation identifier on a particular form by the user. A writing utensil (for example, a pen) is equipped with an emitter for emitting a signal that will be received by one or more receptors located on the base station. When the writing utensil is used, the base station performs triangulation to determine the relative position of the distal tip of the writing utensil while the user is writing or drawing on the sheet of paper.

The base station also contains a detector, such as a photosensor, an IR transmitter/receiver, a laser scanner, or a digital camera that is capable of detecting the form identifier and/or orientation identifier. In embodiments where a form has an orientation identifier, because the orientation identifier is located on the sheet of paper in a known location, the base station can determine the precise orientation of the sheet of paper with respect to the base station. The orientation can be used to determine the precise location of the user's writing on the sheet of paper—one form of absolute positioning. In embodiments where the form has a form identifier, the base station is able to identify the exact form instance of the form being written on. Thus, the form identification can be used to determine aspects of the form which should be taken into account with the relative position of the pen—another form of absolute positioning. In one example, the form instance identifies a particular user for which the form is intended and particular form fields located on the form. The form field information can be used in combination with the orientation to identify the context of particular handwriting that has been captured in a particular field using the digital pen.

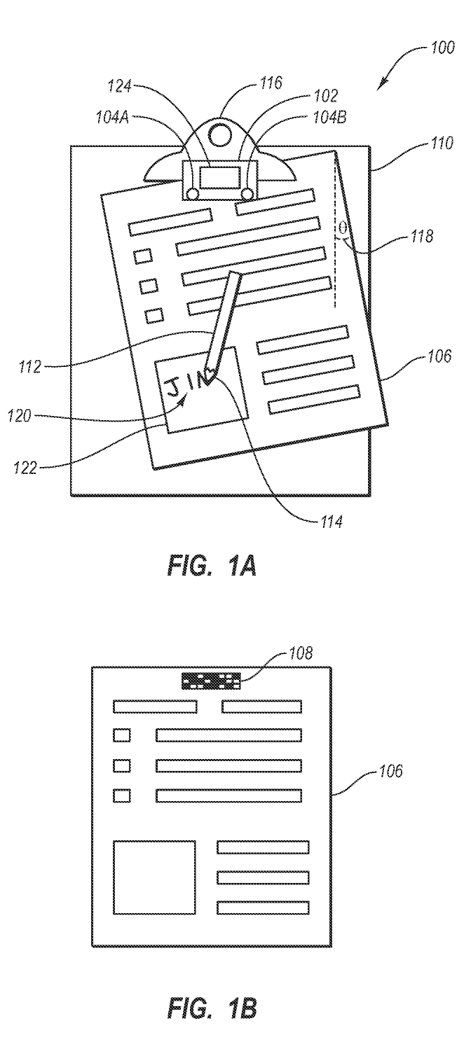

Referring now to FIG. 1A, more detail of an example system, denoted generally at 100, is illustrated wherein a digital pen system may be implemented. The illustrated system 100 includes a clipboard 110 having a clamp 116, the clamp providing a support structure for a base station 102. Although a clipboard 110 is used as the support structure in the illustrated embodiment, it will be appreciated that any support structure may be used for mounting the base station 102, such as a table, whiteboard, a desk, a portable device carried by a person, and the like. A user secures a form 106 in the clipboard 110 using a conventional clamp 116. In the present example embodiment, the base station 102 is secured on the clamp 116 such that when the form 106 is placed underneath the clamp 116, the base station 102 is also placed over at least a portion of the form 106.

The example system 100 also includes a writing utensil 112, which may include a pen, a marker, a pencil, a stylus, and the like. The writing utensil 112 includes at least one emitter 114. The emitter 114 may be located near or at the distal end of the writing utensil 112. The emitter 114 may emit any type of signal that may be detected by the base station 102 for performing triangulation. For example, the emitter 114 may emit radio frequencies (“RF”) signals, ultrasonic audio signals, infrared signals, and the like. So as not to obscure the present invention, the writing utensil 112 will not be described in further detail since those of skill in the art would recognize how to construct a writing utensil 112 capable of emitting signals.

The base station 102 may include a reasonably sized device (for example, three inch by one inch), which receives the signal sent by the writing utensil 112 via two or more receptors 104A and 104B located on the sides of the base station 102. The base station 102 uses receptors 104A and 104B to determine the relative position of the writing device 112. The relative position of the writing device merely describes the location of the writing device 112 with respect to the base station 102, and does not account for the orientation nor identification of form 106. Various techniques may be used for determining the relative position of the writing device.

For example, the time difference of arrival between the writing utensil's signals to the receptors 104A and 104B may allow the base station 102 to triangulate the relative position of the writing utensil 112 very precisely. Other examples include general multilateration techniques relating to time difference of arrival calculation of a signal transmitted from the emitter to three or more receivers. Another variation of time difference calculations is phase difference analysis where phase information, such as light or a time-varying signal (such as a ‘chirp’ or repeating sequence of continuously-varying frequencies) are detected to calculate the ‘phase’ (i.e., which ‘note is heard first in the sequence). In addition, another variation of multilateration is to identify and use a signal strength of the signal transmitted from the emitter by the receivers to determine the distance the emitter is from the base station.

However, oftentimes, a form 106 being written on by the user may be slightly disoriented with respect to the clipboard 110 and/or the base station 102. For instance, in the example illustrated in FIG. 1A, a form 106 is rotated by an angle θ 118 with respect to the clipboard 110 and the base station 102. In addition, the form 106 may be displaced from the central x and/or y axis of the clipboard 110. Therefore, if the base station 102 presumes that the form 106 is centered perfectly with respect to the clipboard 110 and the base station 102, then the digital handwritten document generated by the base station 102 would not match the writing as intended by the user. For instance, the form 106 may have a particular field 122 to be filled out by the user, the writing 120 generated by the user being intended to be included within the box 122 of the form. However, because the form 106 is rotated with respect to the clipboard 110 and the base station 102, the user will likely write within the box 122 of the actual form 106 while a digital document produced from this data would show the writing 120 disposed at an angle in box 122, unless the rotation of the form 106 is compensated for. Furthermore, when handwriting recognition is required, an analyzing system would recognize different information in the box 122 than what the user actually thought s/he was placing in box 122 since the form was placed on the clipboard 110 at an angle θ. Misorientation can become especially onerous where form fields are small, such as radial fields, checkboxes, character/number fields, and the like.

In order to compensate for the orientation of the form 106, the base station 102 includes means for detecting the orientation of an identifier 108 that is located on the form 106, as illustrated in FIG. 1B. Such a means can include a detector (not shown), which is described in further detail below. The identifier 108 may include an orientation portion that includes any marking placed at a known location on the form 106 that can be used by the orientation identifier of the base station 102 for determining the orientation of the form 106 with respect to the base station 102. In the example illustrated in the FIG. 1B, the identifier 108 includes a simple two dimensional bar code that may be printed directly on a form 106 at a known location. The orientation identifier of the base station may be located on the underside of the base station 102 for detecting the identifier 108 on the form 106.

Upon detecting the identifier 108, the base station 102 may use data determined from the orientation portion to determine the orientation of the form 106 with respect to the base station 102. The base station 102 may then apply a compensation or reorientation factor to the relative position of the writing utensil 112, as measured at the receptors 104A and 104B, so that the handwriting captured by the base station 102 can be adjusted as needed in the digital version of form 106, as intended by the user in the actual form 106. By applying the compensation factor to the relative position of the writing utensil 112, one type of “absolute position” of the writing utensil can be determined, which accounts for any offset, rotation or misalignment of the form 106. Thus, in a digital environment, the handwriting can be recreated and correlated with certain information fields that the form was intended to capture.

As described above, the identifier 108 illustrated in the FIG. 1B example includes a two dimensional barcode. Because the two dimensional barcode may have a rectangular shape, the detector within the base station 102 may use the border and/or other lines within the barcode to determine the angle at which the paper is oriented and/or the distance in the x or y direction that the form is offset from the base station.

While one specific use of the identifier 108 is to identify that reorientation is necessary, another use of the identifier 108 is to identify when exact orientation is not necessary, thus indicating a freestyle mode. A freestyle mode allows a user to write without regard to placing handwriting in a particular field. The compensation factor can still be used to produce the freestyle in the same orientation in which it was created.

Another function that the identifier 108 can perform (in cooperation with or independent of acting as an orientation identifier) is to identify a particular form identity, which can provide a form of “absolute positioning” having form identity providing context information as to how the relative positioning of the pen is being used. A form may have specified fields in which certain information is required to be input by a user. Identifying a form thus allows a host process to determine that the form has certain data fields, each field located in a certain location on the form for performing handwriting capture and/or recognition. This can be advantageous where an organization may use tens to hundreds of different forms, or variations of forms, each of which can be particularly identified using a unique identifier 108. Further, the form identifier can uniquely distinguish one printed copy (i.e., form instance) of a given template from another, along with a variety of other form instance information such as its specific processing instruction, page number, page size, the location of the form identifier on the form, the size of the form identifier, a unique form instance ID, and the like. For example, an education organization may use a forms-implemented test where the form fields look exactly the same, but correspond to different testing booklets that are uniquely assigned to each test-taker to prevent test-takers from cheating.

Such means for identifying a form identity can include a detector, described in more detail below. It is worth noting that the present invention contemplates that the form identifier can operate independently of the orientation identifier. This can be manifest by having only a form identifier or only an orientation identifier on the form. Alternatively, this can be manifest by having the form identifier in a different location than an orientation identifier and having separate detectors identify them independently, although designers in most cases would likely opt for a single detector identifying both the form identifier and the orientation identifier. By containing both a form identifier and an orientation identifier, the captured handwriting can be resolved relative to a form's content. For example, pen strokes in a freestyle field can be interpreted as freestyle, pen strokes in a numeric field can be interpreted as numbers, pen strokes in a character field can be interpreted as characters, and pen strokes in a checkbox can be interpreted as a checkmark. This allows much higher accuracy then is possible with OCR alone on the final digitally-generated form.

In one embodiment, the form identifier portion of the identifier 108 may include a DataMatrix code, ISO specification, ISO/IEC16022. The DataMatrix code may encode a number for identifying the exact copy of the form which is identified by the form identifier. By knowing which form is being used, greater accuracy can be achieved when generating the digital document because the field categories of the form may help perform handwriting recognition techniques. Although a two dimensional barcode is provided in the present example, one of ordinary skill in the art will appreciate that any markings included on a form may be used by the base station 102 for determining the orientation and/or identification of the form. For instance, any 1-D bar code (with widths and spacings of printed parallel lines), 2-D bar code (with widths and spacings of parallel and orthogonal lines), display pattern of dots, lines, polygonal shapes, boxes, concentric circles, coloring, grayscaling, text codes hidden in images, or any other marking may be placed in a known location on a form to be read by a detector on the base station 102 for determining the absolute position of the digital pen form.

In embodiments implementing both a form identifier and an orientation identifier, the form identifier may be separate from the orientation identifier, or alternatively may be integrated with the orientation identifier into a single identifier. For instance, the two dimensional barcode illustrated in the FIG. 1B example may include a form identifier portion containing sufficient data for identifying an instance of the form being used, and may also include an orientation portion containing sufficient placement information for determining the orientation of the form 106.

Therefore, a user of a pen position triangulation system, such as the system 100 illustrated in FIG. 1A, may simply place the identifier 108 underneath the base station 102 to identify the purpose for which the system is being used (i.e., a form or predetermined content) and/or the orientation at which the user is writing compared to the base station 102, and begin writing with a digital pen 112 equipped with an emitter 114. The system automatically detects the user's writing and generates data related to the handwriting session. The orientation and/or form identification data are used to provide context to the relative position of the pen to be used to define an absolute position of the pen. The data can then be transferred (e.g., pushed or pulled) to a host processor and/or database. Therefore, a user of the system 100 can simply fill out a form or other handwritten document in a manner that, from the user's prospective, is similar to writing on any conventional form. The process of creating the digitized document may be performed with little or no manual user input.

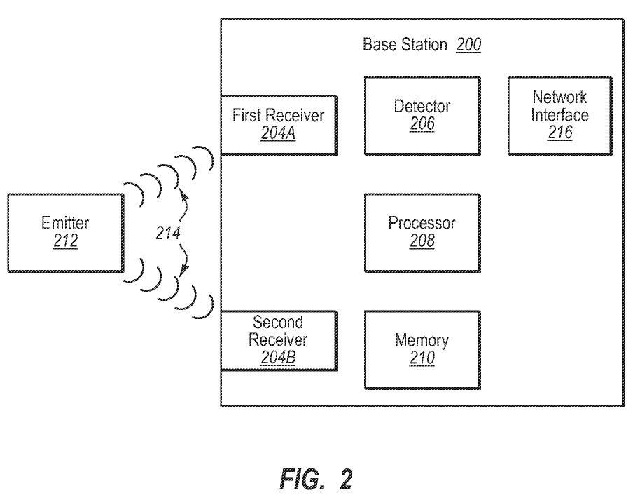

Referring now to FIG. 2, a more detailed schematic diagram of the base station 200 is provided. The base station 200 receives the signals 214 emitted by the emitter 212 via the first and second receivers 204A and 204B. The receivers 204A, 204B can depend on the type of signal emitted. For example, where the emitter 212 is a sonar signal, the receivers 204A, 204B can be microphones that detect sonar signals. As mentioned above, the emitter 212 can be located on a writing utensil. In the illustrated embodiment, a processor 208 located within the base station 200 receives the signals from the first and second receivers 204A and 204B and determines the precise location of the emitter 212. A detector 206 located at the bottom of the base station 200 detects the identifier 108, which may include an orientation identifier and/or a form identifier. The configuration of the detector 206 depends on the type of identifier 108. For example, where the identifier 108 is a 2-D barcode, the detector 206 may be a photosensor, an IR transmitter/receiver, a laser scanner, a digital camera, or the like. As mentioned above, the identifier 108 can be located on the form 106, or found in another location, such as an ID card carried by a person.

Typically, the processor 208 merely performs minimal preprocessing required prior to storing the data collected by the first and second receivers 204A and 204B in memory 210. The data stored in memory 210 is then uploaded to a remote computer or server using network interface 216. The remote computer or server performs processing required to recreate a digital version of the form 106 being written on by the user, including any markings made by the user using the writing utensil 112. The memory 210 can store varying levels of information. The memory 210 can store just the data from receivers 204A, 204B, which can then the transmitted to a remote processor to perform the triangulation algorithms. The memory 210 can store orientation information which is transmitted to a remote processor and used in the triangulation algorithms. The memory can also store just form identifier information which can be transmitted to a remote processor to correlate the positioning of the digital pen with certain content fields or other aspects of the form. In other words, the memory 210 can store any combination of relative positioning, orientation, and/or form identifier information depending on the configuration of the digital pen system. However, in another embodiment, the processor 208 can perform some or all of the functions of the remote server, the resultant data being stored in memory 210 and then transmitted to the remote server.

The form identification portion of the identifier 108 may be used in two ways. First, and in one embodiment, in a passive mode, the base station 102 maintains little or no information about the instance of the form that is identified by the form identifier. In this embodiment, the base station 102 provides little or no form specific feedback to the user while the user is filling out the form. However, upon uploading the data to a central server or computer, the server uses information regarding the form in order to generate a digitized document.

In another embodiment, the form identification portion of the identifier 108 operates in an active mode. In active mode, the base station 102 either contains information about the specific form or can communicate with a remote computer to obtain information about the form once the form identification is known. For example, the base station 102 may retain information such as required fields, optional fields, text fields, checkmark fields, and the like. This information may be maintained in a memory 210 as illustrated in FIG. 2, and may be used for improving handwriting recognition, automated data entry, and the like. Depending on the processing power of the base station processor 208, some or all of the handwriting recognition may be performed locally at the base station so that the business-logic rules can be applied locally, before the data is uploaded to a central server.

In the illustrated embodiment of FIG. 1A, the base station 102 may also include a display 124. The display 124 may include, for example, an LCD display for displaying information or other feedback to the user. The display 124 may, for example, provide instructions to the user, such as which form the user is filling out, as well as how to fill out the form. If errors are made while the user is filling out the form, the display 124 may notify the user immediately so that the user may correct the errors before submitting the data. In one embodiment, the base station 102 may also include one or more buttons (not shown), which allow the user to control the data. For example, a “save” button may be used for saving the handwritten data generated by the user up to that point. The base station 102 may also include an “erase” button that may be used for erasing the most recent mark created by the user, the latest field that has been filled in by the user, or all data submitted by the user after the most recent save. These features may be used for correcting handwriting data immediately. The base station 102 may also include “send” button that may be used for transmitting the data stored in the base station to a remote computer or central server via a wired or wireless communication link.

As described previously, at the remote host or central server, high-order business-logic rules can be applied to the data, and feedback can be sent back to the base station 102 via the wired or wireless communication link to be displayed to the user on the display 124. The display may be useful if the form is filled with values that may appear to be correct, but do not correspond to valid entries in the database. For example, the database may expect to receive an email address, but instead may receive data that does not correspond to a valid email address. The base station 102 may also include any other combination of displays, buttons, lights, and the like. However, typically the base station 102 will be relatively simply configured such that a lay person can use the digital pen.

While the base station 102 has been described above as a single unit, components of the base station 102 may be separable. For example, the first and second receivers 204A, 204B may be located at a remote computer while the detector 206 is located on a clipboard. One or more components of the base station 102 may be located on the writing utensil 112. However, having the detector on base station 102 separate from the writing utensil 112 provides various advantages with regard to identifying context of the form to determine absolute position of the pen. Where the form may shift or move during use, the detector can use the orientation identifier to perform dynamic orientation analysis to correlate certain compensation factors at certain points in time so that the digital version of the form is reproduced more accurately. Another advantage of having the base station 102 separate from the pen is that the size of the form is not limited. The form identifier can be placed anywhere on the form and used to provide the absolute position information for even very large forms. If the form is a map on which a user is writing, a small form identifier can be located on a corner of the map and the base station placed over the form identifier. The user can then use the writing utensil to write on the map and the form identifier can contain location data of coordinates on the map to provide the absolute position of the pen at any location on the map. Other configurations are also possible as will be understood to one of skill in the art.

In one embodiment, memory 210 is a non-volatile memory, providing data security and integrity to data if power is lost. The data may then be transmitted over a secure link, such as HTTPS using client certificates. The non-volatile memory will never be erased before the data has been successfully uploaded. In one embodiment, a checksum may be calculated on the data by both the base station 202 and the remote computer or central server. The checksums may be compared to ensure that the data was sent correctly.

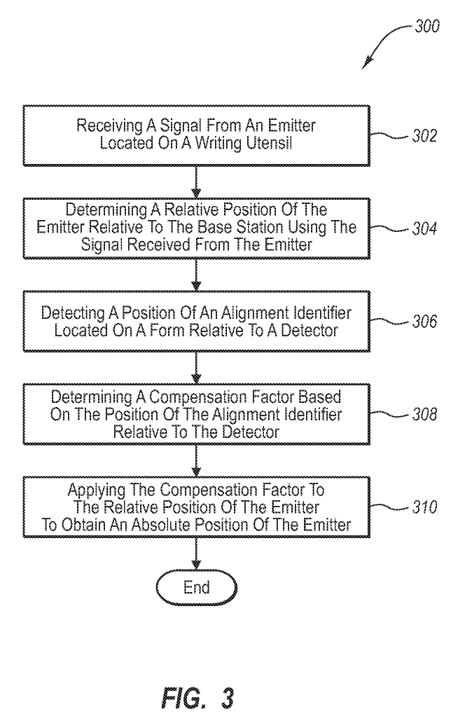

FIG. 3 illustrates one embodiment of a method 300 of performing handwriting capture. The method 300 includes, at 302, receiving a signal from an emitter located on a writing utensil. At 304, the method determines the relative position of the emitter relative to a base station using the signal from the emitter. In one embodiment, receiving a signal from an emitter may include receiving more than one signal from the emitter from which can be determined the relative position of the emitter. The signals received from the emitter may include ultrasonic audio signals, RF signals, IR signals, and the like.

The method 300 also includes, at 306, detecting an orientation identifier located on a form relative to a detector. The orientation identifier may be located at a known location on a form, such as a piece of paper or form layout. The orientation identifier may be detected using a photosensor, an IR transmitter/receiver, a laser scanner, or a digital camera, or any other type of detector. In one embodiment, the detector can be located on the base station. The detector can determine whether enough of the orientation identifier is located in the detecting area and signal to the user if the detector is not able to adequately evaluate the orientation.

The method 300 further includes, at 308, determining a compensation factor based on the orientation of the orientation identifier relative to the detector. In one embodiment, determining a compensation factor further includes using the orientation of the orientation identifier to determine an orientation of the form in relation to the detector.

At 310, the method 300 also includes applying the compensation factor to the relative position of the emitter to obtain an absolute position of the emitter. As described previously, the absolute position of the emitter describes substantially the exact location of the emitter with respect to the orientation identifier, and therefore, with respect to the form.

In one embodiment, the method 300 may be used for generating a handwritten digital document using the absolute position of the at least one emitter. Alternatively, the method 300 may further be used for interpreting digitized form data using the absolute position of the at least one emitter. In this case, the method 300 may also detect a form identifier located on the form for identifying an instance of a form. The digitized form data may be interpreted as described previously by further defining the absolute positioning of the digital pen to include the context of data fields within the form layout.

The method 300 may also include displaying information regarding data capture to a user of the system. For example, an LCD, keyboard, LEDs, or other type of user interface may be used for displaying information to the user. In one embodiment, the method may interact with the user for allowing the user to correct the relative position of the emitter. In other words, when an error is made by the user, the method 300 may allow the user to correct the error via a display or other user interface.

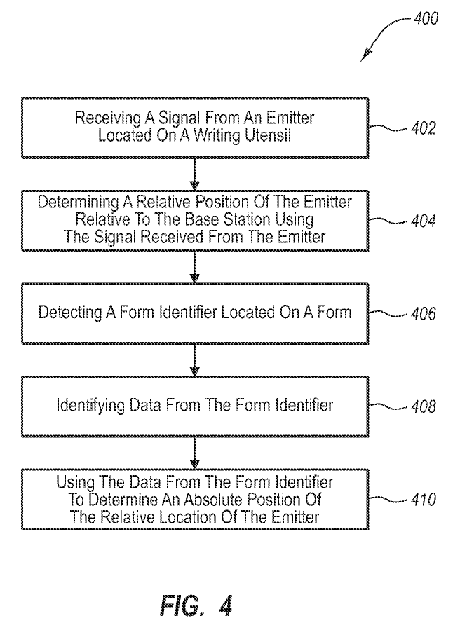

FIG. 4 illustrates one embodiment of a method 400 of performing handwriting capture. The method 400 includes, at 402, receiving a signal from an emitter located on a writing utensil. At 404, the method determines the relative position of the emitter relative to a base station using the signal from the emitter. In one embodiment, receiving a signal from an emitter may include receiving more than one signal from the emitter from which can be determined the relative position of the emitter. The signals received from the emitter may include ultrasonic audio signals, RF signals, IR signals, and the like.

The method 400 also includes, at 406, detecting a form identifier located on a form. The form identifier may be detected using a photosensor, an IR transmitter/receiver, a laser scanner, or a digital camera, or any other type of detector. In one embodiment, the detector can be located on the base station. The detector can determine whether enough of the form identifier is located in the detecting area and signal to the user if the detector is not able to adequately evaluate the form identity.

The method 400 further includes, at 408, identifying data from the form identifier. Such data can include, but is not limited to, a form identity, one or more fields in the form, a form instance, processing instructions, page number, page size, a size and/or location of the form identifier, or the like.

At 410, the method 400 also includes using the data from the form identifier to determine an absolute position of the relative location of the emitter, the absolute position of the emitter defining at least a context of the form with respect to the relative position of the emitter. Thus, such actions for using the form identifier data to determine an absolute position of the emitter can include, but is not limited to, storing the form identity and associating the form identity with particular handwriting capture data, identifying particular fields in the form and associating the particular fields with particular handwriting capture data, identifying a particular form instance of the form and associating the form instance with handwriting data, identifying specific processing instructions included in the form identifier and associating with particular handwriting capture data for a host processor to use in processing the handwriting capture data, identifying a page number of the form and including the page number with handwriting capture data, identifying a page size defined by the form identifier and using the page size to determine whether the pen is within the boundary of the defined page size, associating the page size with handwriting capture data to define a digitally generated page size, or identifying the location and/or size of the form identifier to determine whether the detector is identifying all of the information contained in the form identifier, and the like.

In one embodiment, the method 400 may be used for generating a handwritten digital document using the absolute position of the at least one emitter. Alternatively, the method 300 may further be used for interpreting digitized form data using the absolute position of the at least one emitter. That is, when the context of the form is known, handwriting recognition can be performed in the context of particular fields or to determine whether information required in particular fields was provided by the user. In one embodiment, the method 400 may also detect an orientation identifier located on the form for identifying an orientation of a form. The digitized form data may be interpreted as described previously by further defining the absolute positioning of the digital pen to include the orientation of the form layout. Another action that can be performed using the form identifier is to determine whether the display should be operated in a passive or active mode, wherein the active mode provides feedback to a user filling out the form.

Embodiments included general-purpose and/or special-purpose devices or systems that include both hardware and/or software components. Embodiments may also include physical computer-readable media and/or intangible computer-readable media for carrying or having computer-executable instructions, data structures, and/or data signals stored thereon. Such physical computer-readable media and/or intangible computer-readable media can be any available media that can be accessed by a general purpose or special purpose computer. By way of example, and not limitation, such physical computer-readable media can include RAM, ROM, EEPROM, CD-ROM or other optical disk storage, magnetic disk storage or other magnetic storage devices, other semiconductor storage media, or any other physical medium which can be used to store desired data in the form of computer-executable instructions, data structures and/or data signals, and which can be accessed by a general purpose or special purpose computer. Within a general purpose or special purpose computer, intangible computer-readable media can include electromagnetic means for conveying a data signal from one part of the computer to another, such as through circuitry residing in the computer.

When information is transferred or provided over a network or another communications connection (either hardwired, wireless, or a combination of hardwired or wireless) to a computer, hardwired devices for sending and receiving computer-executable instructions, data structures, and/or data signals (e.g., wires, cables, optical fibers, electronic circuitry, chemical, and the like) should properly be viewed as physical computer-readable mediums while wireless carriers or wireless mediums for sending and/or receiving computer-executable instructions, data structures, and/or data signals (e.g., radio communications, satellite communications, infrared communications, and the like) should properly be viewed as intangible computer-readable mediums. Combinations of the above should also be included within the scope of computer-readable media.

Computer-executable instructions include, for example, instructions, data, and/or data signals which cause a general purpose computer, special purpose computer, or special purpose processing device to perform a certain function or group of functions. Although not required, aspects of the invention have been described herein in the general context of computer-executable instructions, such as program modules, being executed by computers, in network environments and/or non-network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

Embodiments may also include computer program products for use in the systems of the present invention, the computer program product having a physical computer-readable medium having computer readable program code stored thereon, the computer readable program code comprising computer executable instructions that, when executed by a processor, cause the system to perform the methods of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A pen position triangulation system for use in capturing handwriting of a user, the system comprising:
a base body having a receiver located on the base body and configured to receive a multilateration signal from an emitter located on a writing utensil and to generate data based on the multilateration signal from the emitter;
a detector configured to be placed over at least a portion of a form to detect an orientation identifier located on the form;
a processor configured to communicate with the receiver and to communicate with the detector, the processor configured to identify from the receiver the data based on the multilateration signal from the emitter and to identify from the detector data relating to the orientation identifier, the data identified from the receiver and the detector to be used to determine an absolute position of the emitter, the absolute position of the emitter defining at least a substantially exact position of the emitter with respect to the form; and
a network interface configured to transmit data related to the absolute position of the emitter.

2. The system as recited in claim 1, further comprising a memory configured to communicate with the processor for storing the data identified from the receiver and the detector.

3. The system as recited in claim 2, further comprising at least one of:
wherein at least one of the detector, the processor, or the memory is located on the base body; or
wherein at least one of the detector, the processor, or the memory is located separate from the base body.

4. The system as recited in claim 3, wherein the processor is located on a server, the server further comprising a database, the server configured to determine an absolute position of the emitter.

5. The system as recited in claim 1, wherein the processor is further configured to perform at least one of:
determine from the data related to the orientation identifier an orientation of the orientation identifier in reference to the detector and to generate a compensation factor;
calculate the relative position of the emitter and determine an absolute position of the emitter by adjusting the relative position of the emitter with the compensation factor; or
use the absolute position of the at least one emitter to generate a digital version of handwriting capture data of the user.

6. The system as recited in claim 1, wherein the multilateration signal transmitted from the emitter is selected from a group consisting of an ultrasonic audio signal, a radio frequency (RF) signal, and an infrared (IR) signal.

7. The system as recited in claim 1, wherein at least one of the base body or the detector is separate from the writing utensil.

8. The system as recited in claim 1, wherein the orientation identifier comprises at least one of:
a one dimensional bar code;
a two dimensional bar code;
a two dimensional bar code having a rectangular shape such that the detector can detect a border of the rectangular shape, wherein the data relating to the orientation identifier comprises at least one of an angle at which at least a portion of the border is positioned relative to an “x” axis and/or “y” axis of the form or a distance in an “x” direction or “y” direction that at least a portion of the bar code is offset from a centered (x,y) coordinate of the detector;
a two dimensional bar code having one or more lines within the bar code that can be detected by the detector, wherein the data relating to the orientation identifier comprises at least one of an angle at which at least one of the lines is positioned relative to an “x” axis and/or “y” axis of the form or a distance in an “x” direction or “y” direction that at least a portion of the bar code is offset from a centered (x,y) coordinate of the detector;
a two dimensional bar code comprising data matrix code; or
any pattern of dots, lines, polygonal shapes, boxes, concentric circles, coloring, grayscaling, text codes hidden in images, or combinations thereof.

9. A method for performing handwriting capture, the method comprising:
receiving, at a base station, a multilateration signal from an emitter located on a writing utensil;
determining a relative position of the emitter relative to the base station using the multilateration signal received from the emitter;
detecting an orientation of an orientation identifier located on a form relative to a detector;
determining a compensation factor based on the orientation of the orientation identifier relative to the detector; and
applying the compensation factor to the relative position of the emitter to obtain an absolute position of the emitter, the absolute position of the emitter defining at least a substantially exact position of the emitter with respect to the form.

10. The method as recited in claim 9, further comprising using the absolute position of the emitter to generate a digital version of handwriting capture data of the user.

11. The method as recited in claim 9, wherein receiving, at a base station, a multilateration signal from an emitter located on a writing utensil, further comprises the multilateration signal being selected from a group consisting of an ultrasonic audio signal, a radio frequency (RF) signal, and an infrared (IR) signal.

12. The method as recited in claim 9, wherein receiving, at a base station, a multilateration signal from an emitter located on a writing utensil further comprises receiving a first multilateration signal at a first receiver located on the base station, and receiving a second multilateration signal at a second receiver located on the base station, wherein determining a relative position of the emitter relative to the base station further comprises performing multilateration using at least one of time difference of arrival, phase difference, or signal strength of at least the first multilateration signal and the second multilateration signal received from the emitter.

13. A pen position triangulation system for use in capturing handwriting of a user, the system comprising:
a base body having a receiver located on the base body and configured to receive a multilateration signal from an emitter located on a writing utensil and to generate data based on the multilateration signal from the emitter;
a detector configured to be placed over at least a portion of a form to detect a form identifier located on the form;
a processor configured to communicate with the receiver and to communicate with the detector, the processor configured to identify from the receiver the data based on the multilateration signal from the emitter and to identify from the detector data relating to the form identifier, the data identified from the receiver and the detector to be used to determine an absolute position of the emitter, the absolute position of the emitter defining at least a context of the form with respect to the relative position of the emitter; and
a network interface configured to transmit data related to the absolute position of the emitter.

14. The system as recited in claim 13, further comprising a memory configured to communicate with the processor for storing the data identified from the receiver and the detector.

15. The system as recited in claim 14, further comprising at least one of:
wherein at least one of the detector, the processor, or the memory is located on the base body; or
wherein at least one of the detector, the processor, or the memory is located remote from the base body.

16. The system as recited in claim 15, wherein the processor is located on a server, the server further comprising a database, the server configured to determine an absolute position of the emitter.

17. The system as recited in claim 13, wherein the processor is further configured to perform an action based on data relating to the form identifier, the action comprising at least one of:
determining that the data identified from the detector includes a form identity associated with the form, and associating the form identity with particular handwriting capture data;
determining that the data identified from the detector includes one or more fields associated with the form, and associating the one or more fields with particular handwriting capture data;
determining that the data identified from the detector includes a form instance associated with the form, and associating the form instance with particular handwriting capture data;
determining that the data identified from the detector includes processing instructions, and associating the processing instructions with particular handwriting capture data for a host processor to use in processing the particular handwriting capture data;
determining that the data identified from the detector includes a page number of the form, and associating the page number with particular handwriting capture data;
determining that the data identified from the detector includes a page size of the form, associating the page size with particular handwriting capture data for a host processor to use generating a digital version of the handwriting capture data, and determining whether the particular handwriting capture data is within a boundary defined by the page size; or
determining that the data identified from the detector includes a location and size of the form identifier, and determining whether the detector identified all of the information contained in the form identifier.

18. The system as recited in claim 13, wherein the multilateration signal transmitted from the emitter is selected from a group consisting of an ultrasonic audio signal, a radio frequency (RF) signal, and an infrared (IR) signal.

19. The system as recited in claim 13, wherein at least one of the base body or the detector is separate from the writing utensil.

20. The system as recited in claim 13, wherein the form identifier comprises at least one of:
a one dimensional bar code;
a two dimensional bar code;
a two dimensional bar code having a rectangular shape;
a two dimensional bar code having one or more lines within the bar code;
a two dimensional bar code comprising data matrix code; or
any pattern of dots, lines, polygonal shapes, boxes, concentric circles, coloring, grayscaling, text codes hidden in images, or combinations thereof.

21. A method for performing handwriting capture, the method comprising:
receiving, at a base station, a multilateration signal from an emitter located on a writing utensil;
determining a relative position of the emitter relative to the base station using the multilateration signal received from the emitter;
using a detector to identify a form identifier located on a form;
identifying data from the form identifier; and
using the data from the form identifier to determine an absolute position of the emitter, the absolute position of the emitter defining at least a context of the form with respect to the relative position of the emitter.

22. The method as recited in claim 22, wherein using the data from the form identifier to determine an absolute position of the emitter further comprises at least one of:
determining that the data identified by the detector includes a form identity associated with the form, and associating the form identity with particular handwriting capture data;
determining that the data identified by the detector includes one or more fields associated with the form, and associating the one or more fields with particular handwriting capture data;
determining that the data identified by the detector includes a form instance associated with the form, and associating the form instance with particular handwriting capture data;
determining that the data identified by the detector includes processing instructions, and associating the processing instructions with particular handwriting capture data for a host processor to use in processing the particular handwriting capture data;
determining that the data identified by the detector includes a page number of the form, and associating the page number with particular handwriting capture data;
determining that the data identified by the detector includes a page size of the form, associating the page size with particular handwriting capture data for a host processor to use generating a digital version of the handwriting capture data, and determining whether the particular handwriting capture data is within a boundary defined by the page size; or
determining that the data identified by the detector includes a location and size of the form identifier, and determining whether the detector identified all of the information contained in the form identifier.

23. The method as recited in claim 22, wherein receiving, at a base station, a multilateration signal from an emitter located on a writing utensil, further comprises the multilateration signal being selected from a group consisting of an ultrasonic audio signal, a radio frequency (RF) signal, and an infrared (IR) signal.

24. The method as recited in claim 22, wherein receiving, at a base station, a multilateration signal from an emitter located on a writing utensil further comprises receiving a first multilateration signal at a first receiver located on the base station, and receiving a second multilateration signal at a second receiver located on the base station, wherein determining a relative position of the emitter relative to the base station further comprises performing multilateration using at least one of time difference of arrival, phase difference, or signal strength of at least the first multilateration signal and the second multilateration signal received from the emitter.
